(19) United States
(12) Patent Application Publication
(10) Pub. No.: US 2026/0067958 A1
(43) Pub. Date: Mar. 5, 2026

(54) METHODS, ARCHITECTURES, APPARATUSES AND SYSTEMS FOR TRANSMISSION AND RECEPTION IN MULTIPATH SIDELINK RELAYING

(71) Applicant: InterDigital Patent Holdings, Inc., Wilmington, DE (US)

(72) Inventors: Martino Freda, Laval (CA); Tuong Hoang, Montreal (CA); Oumer Teyeb, Montreal (CA); Ananth Kini, Conshohocken, PA (US)

(21) Appl. No.: 18/993,416

(22) PCT Filed: Jul. 11, 2023
(86) PCT No.: PCT/US2023/027336

§ 371 Date: Jan. 10, 2025

Related U.S. Application Data
(60) Provisional application No. 63/359,980, filed on Jul. 11, 2022.

(51) Int. Cl. H04W 76/14; H04W 76/15

(52) U.S. Cl. CPC H04W 76/14; H04W 76/15

(57) ABSTRACT

Procedures, methods, architectures, apparatuses, systems, devices, and computer program products for flexible transmissions in multipath sidelink relaying. A wireless transmit-receive unit, WTRU, may be configured with a bearer configured for multipath. Such a bearer may have a common, Uu, PDCP layer, but have two separate RLC entities associated with it—a Uu RLC entity for transmission/reception directly on Uu, and a SL RLC entity for transmission/reception via SL, to a WTRU to NW relay. Data on a multipath bearer can be transmitted via the Uu path, the SL path, or both, i.e., duplication. In the case the WTRU is configured for duplication, or decides to enable duplication for a multipath bearer (a duplication bearer), the WTRU may transmit PDCP PDUs both over the Uu path and the SL path.

### CROSS-REFERENCE TO RELATED APPLICATIONS

This application claims the benefit of U.S. Provisional Patent Application No. 63/359,980 filed 11 Jul. 2022, which is incorporated herein by reference.

### FIELD

The present disclosure is generally directed to the fields of communications, software and encoding, including, for example, to methods, architectures, apparatuses, systems directed to transmission and reception in multipath sidelink relaying.

### BACKGROUND

The 3GPP specifications have introduced layer 2 User Equipment (UE) (or wireless receive-transmit unit (WTRU)) to network (NW) relays (U2N relays). The main use case considered in these specifications is the case of a remote UE/WTRU out of coverage. It would be desirable to provide solutions for multipath.

### SUMMARY

There are disclosed embodiments of methods, as described in the following and as claimed in the appended claims.

There are disclosed embodiments of a WTRU, as described in the following and as claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a user plane protocol stack for L2 U2N relay;

FIG. 3 is a control plane protocol stack for L2 U2N relay;

FIG. 4 is a flow chart of a method according to an embodiment.

FIG. 5 is a flow chart of a method according to an embodiment.

FIGS. 6a and 6b illustrate embodiments.

FIG. 7 is a flow-chart of an embodiment of a method implemented by a wireless transmit-receive unit.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

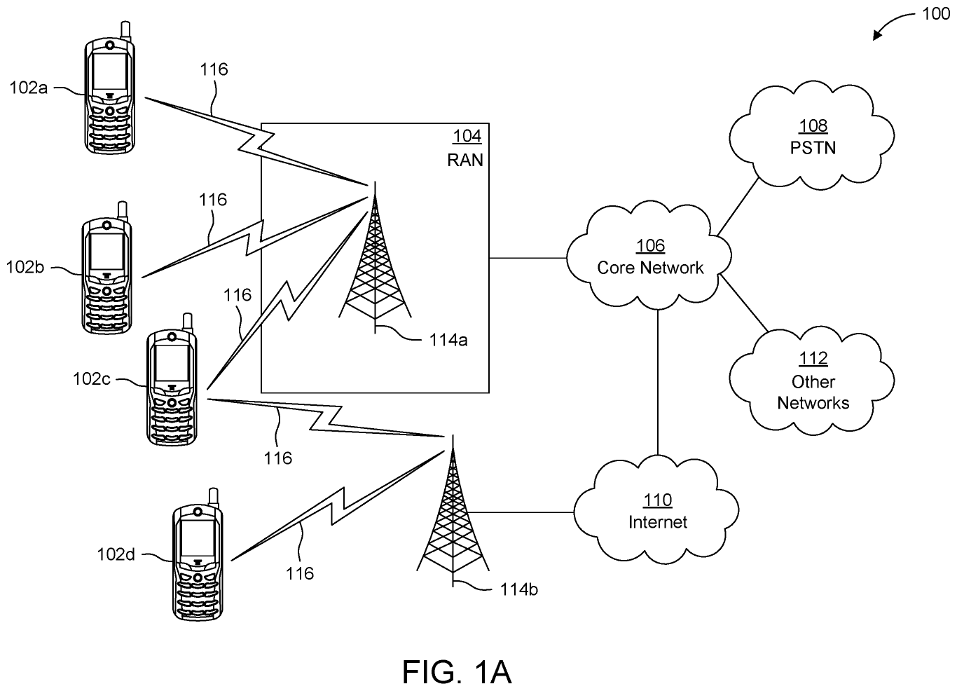

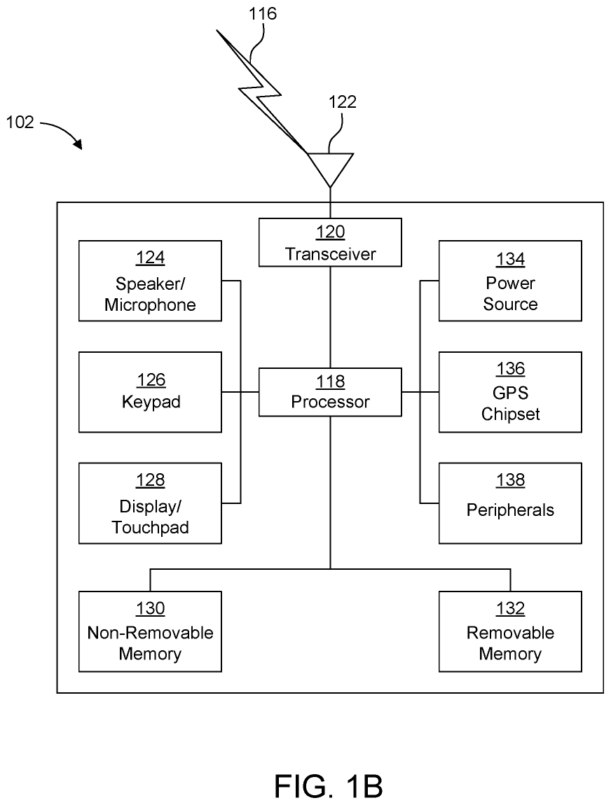

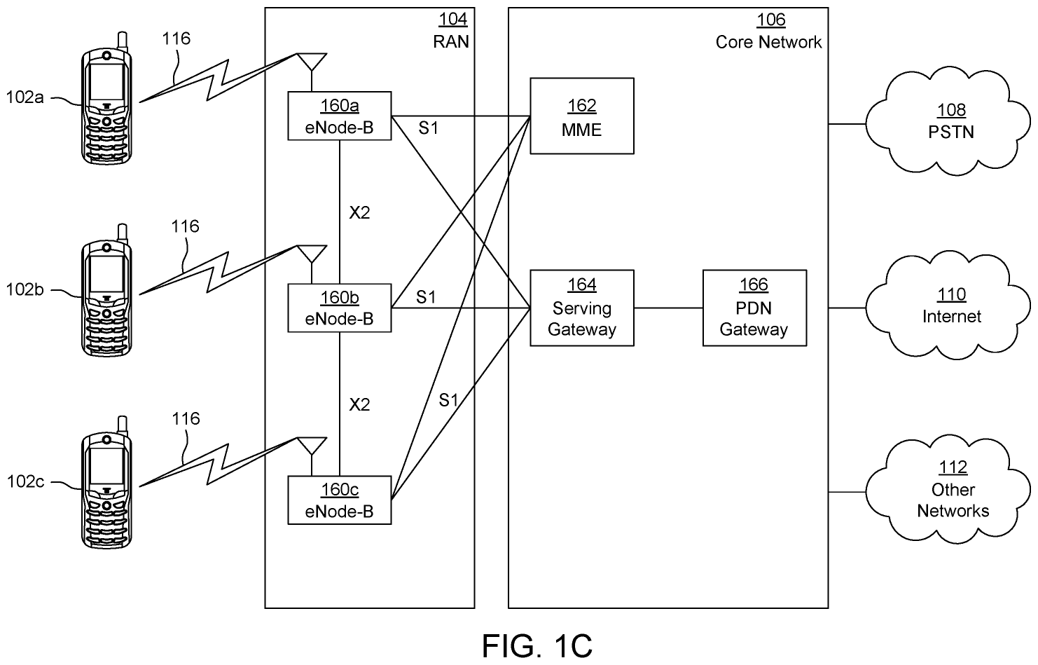

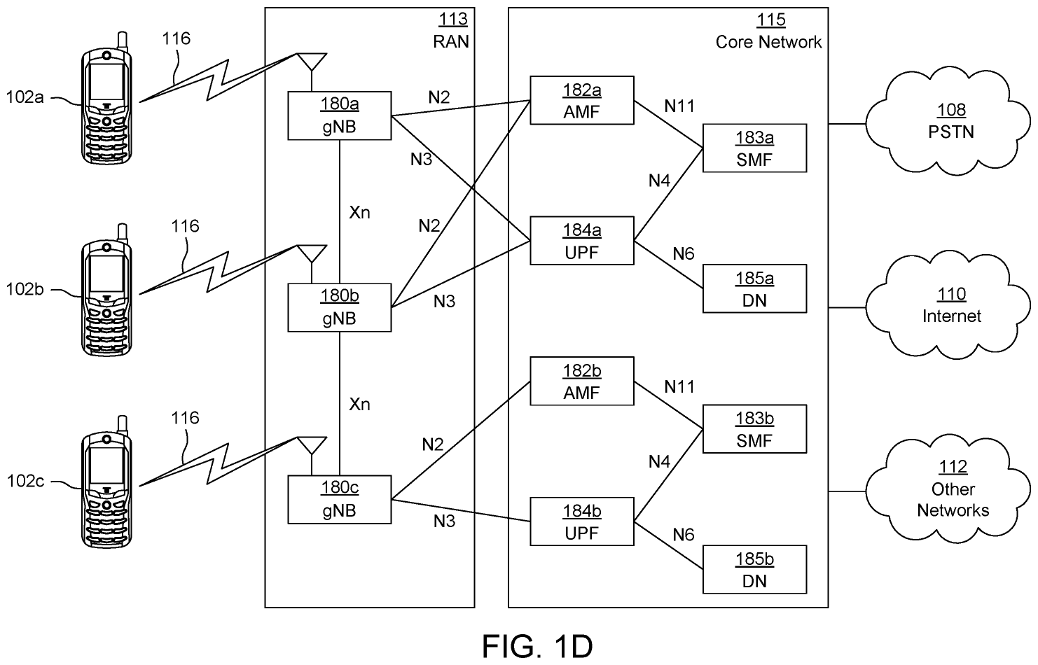

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-ID, and the corresponding description of FIGS. 1A-ID, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

3GPP specifications have specified SL-based WTRU to Network Relays. Sidelink relay is introduced to support 5G ProSe WTRU-to-Network Relay (or UE-to-Network Relay, i.e., U2N Relay or WTRU2NW relay) function to provide connectivity to the network for U2N Remote WTRU(s). Both L2 and L3 U2N Relay architectures are supported. The L3 U2N Relay architecture is transparent to the serving RAN of the U2N Relay WTRU, except for controlling sidelink resources.

A U2N Relay WTRU is in RRC_CONNECTED to perform relaying of unicast data.

For L2 U2N Relay operation, the following Radio Resource Control (RRC) state combinations are supported:
Both U2N Relay WTRU and U2N Remote WTRU are in RRC CONNECTED to perform transmission/reception of relayed unicast data; and
The U2N Relay WTRU may be in RRC_IDLE, RRC_INACTIVE or RRC_CONNECTED state as long as all the U2N Remote WTRU(s) that are connected to the U2N Relay WTRU are either in RRC_INACTIVE or in RRC IDLE state.

For L2 U2N Relay, the U2N Remote WTRU can only be configured to use resource allocation mode 2 for data to be relayed.

A single unicast link is established between one L2 U2N Relay WTRU and one L2 U2N Remote WTRU. The traffic of U2N Remote WTRU via a given U2N Relay WTRU and the traffic of the U2N Relay WTRU shall be separated in different Uu Radio Link Control (RLC) channels over Uu.

### Overview

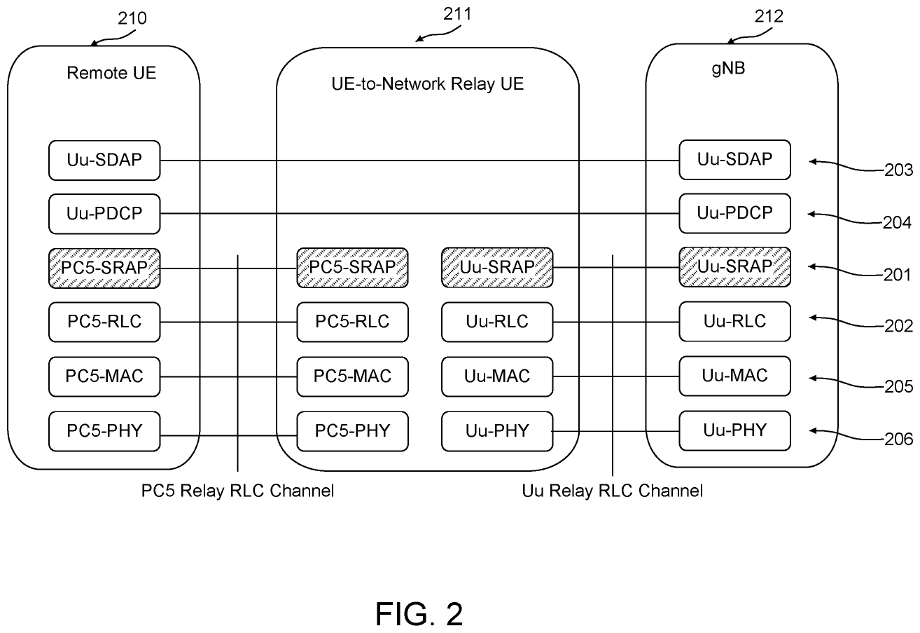

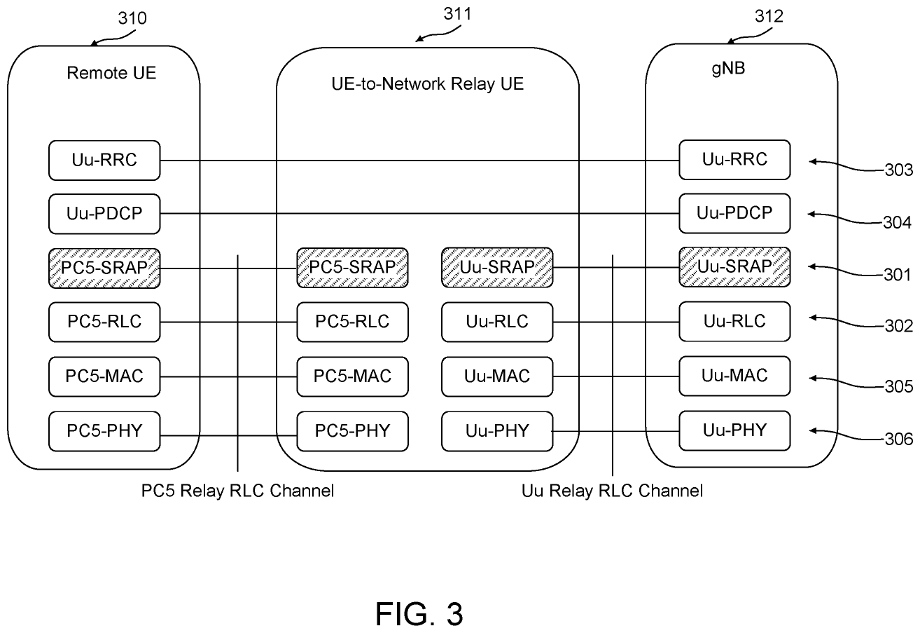

The protocol stacks for the user plane (UP) and control plane (CP) of L2 U2N Relay architecture are presented in FIGS. 1 and 2, wherein FIG. 2 is a user plane protocol stack for L2 U2N relay (211), and FIG. 3 is a control plane protocol stack for L2 U2N relay (311). The Sidelink Relay Adaptation Protocol (SRAP) sublayer (emphasized in FIGS. 2 (201) and 3 (301)), is a layer that is introduced for relay to help the relay perform packet routing. The SRAP sublayer is placed above the RLC sublayer (202, 302) for both CP and UP at both PC5 interface and Uu interface. The Uu Service Data Adaptation Protocol (SDAP) (203, 303), Packet Data Convergence Protocol (PDCP) (204, 304) and RRC are terminated between L2 U2N Remote WTRU (210, 310) and gNB (212, 312), while SRAP, RLC, MAC (205, 305) and PHY (physical layer) (206, 306) are terminated in each hop (i.e., the link between L2 U2N Remote WTRU and L2 U2N Relay WTRU and the link between L2 U2N Relay WTRU and the gNB).

For L2 U2N Relay, the SRAP sublayer over PC5 hop is only for the purpose of bearer mapping. The SRAP sublayer is not present over PC5 hop for relaying the L2 U2N Remote WTRU's message on Broadcast Control Channel (BCCH) and Paging Control Channel (PCCH). For L2 U2N Remote WTRU's message on Signaling Radio Bearer 0 (SRB0), the SRAP sublayer is not present over PC5 hop, but the SRAP sublayer is present over Uu hop for both DL and UL.

For L2 U2N Relay, for uplink:
The Uu SRAP sublayer supports UL bearer mapping between ingress PC5 Relay RLC channels for relaying and egress Uu Relay RLC channels over the L2 U2N Relay WTRU Uu interface. For uplink relaying traffic, the different end-to-end RBs (SRBs or DRBs) of the same Remote WTRU and/or different Remote UEs can be multiplexed over the same Uu Relay RLC channel;
The Uu SRAP sublayer supports L2 U2N Remote WTRU identification for the UL traffic. The identity information of L2 U2N Remote WTRU Uu Radio Bearer and a local Remote WTRU ID are included in the Uu SRAP header at UL in order for gNB to correlate the received packets for the specific PDCP entity associated with the right Uu Radio Bearer of a Remote WTRU;
The PC5 SRAP sublayer at the L2 U2N Remote WTRU supports UL bearer mapping between Remote WTRU Uu Radio Bearers and egress PC5 Relay RLC channels.

For L2 U2N Relay, for downlink:
The Uu SRAP sublayer supports DL bearer mapping at gNB to map end-to-end Radio Bearer (Signaling Radio Bearer (SRB), Data Radio Bearer (DRB)) of Remote WTRU into Uu Relay RLC channel over Relay WTRU Uu interface. The Uu SRAP sublayer supports DL bearer mapping and data multiplexing between multiple end-to-end Radio Bearers (SRBs or DRBs) of a L2 U2N Remote WTRU and/or different L2 U2N Remote UEs and one Uu Relay RLC channel over the Relay WTRU Uu interface;
The Uu SRAP sublayer supports Remote WTRU identification for DL traffic. The identity information of Remote WTRU Uu Radio Bearer and a local Remote WTRU ID are included into the Uu SRAP header by the gNB at DL in order for Relay WTRU to map the received packets from Remote WTRU Uu Radio Bearer to its associated PC5 Relay RLC channel;
The PC5 SRAP sublayer at the Relay WTRU supports DL bearer mapping between ingress Uu Relay RLC channels and egress PC5 Relay RLC channels;
The PC5 SRAP sublayer at the Remote WTRU correlates the received packets for the specific PDCP entity associated with the right Uu Radio Bearer of a Remote WTRU based on the identity information included in the Uu SRAP header.

A local Remote WTRU ID is included in both PC5 SRAP header and Uu SRAP header. L2 U2N Relay WTRU is configured by the gNB with the local Remote WTRU identifier (ID) to be used in SRAP header. The Remote WTRU obtains the local Remote ID from the gNB via Uu RRC messages including RRCSetup, RRCReconfiguration, RRCResume and RRCReestablishment. Uu DRB(s) and Uu SRB(s) are mapped to different PC5 Relay RLC channels and Uu Relay RLC channels in both PC5 hop and Uu hop.

It is the gNB's responsibility to avoid collision on the usage of local Remote WTRU ID. The gNB can update the local Remote WTRU ID by sending the updated local Remote ID via RRCReconfiguration message to the Relay WTRU. The serving gNB can perform local Remote WTRU ID update independent of the PC5 unicast link L2 ID update procedure.

### Multipath

The 3GPP specifications have introduced layer 2 WTRU to NW relays. The main use case considered is the case of a remote WTRU out-of-coverage. Specification of multipath is desired; in multipath, the remote WTRU is assumed to be in-coverage and can therefore utilize either the Uu path, the SL (relayed) path, or both.

### Scheduling in Sidelink

Sidelink supports two scheduling modes (scheduling is the process of allocating resources for transmitting data)—known as (resource allocation-, scheduling-) ‘mode 1’ and ‘mode 2’. For an in-coverage WTRU, the gNB can control whether a WTRU transmits using mode 1 or mode 2.

In mode 1 scheduling, which can be used for a sidelink WTRU in RRC_CONNECTED, a WTRU receives SL grants directly from the network in DCI (Downlink Control Information). In this case, the WTRU reports buffer status for SL data grouped by a destination index (where a destination index corresponds to a unique L2 destination ID, or pair of source/destination L2 ID). The WTRU can report SL SR (Scheduling Request) if a SL grant is not available for transmission of the pending data.

In mode 2 scheduling, which can be used by a WTRU in any RRC state, or a WTRU which is out of coverage, a WTRU is configured with a resource pool from which it performs autonomous resource selection and scheduling. Resources are selected by the WTRU based on information in previous Sidelink Control Information (SCI) transmissions by other WTRUs (i.e. sensing results).

Multipath allows the WTRU to save power by using the relayed path while maintaining the possibility of using the Uu path for robustness. In case of a static configuration (controlled by the network) of the UL path, there may be loss of low-latency packets when it is needed to switch from one path to another path. Similarly, depending on a static configuration of duplication could result in packet loss, since it may be possible that the NW signaling needs to be sent via the relayed path, which could be time consuming. Finally, there may be temporary situations where one of the two links for duplication cannot be used, which would reduce the reliability offered by duplication.

According to the present principles, a WTRU may be configured with a bearer configured for multipath. Such a bearer may have a common (Uu) PDCP layer, but have two separate RLC entities associated with it—a Uu RLC entity for transmission/reception directly on Uu, and a SL RLC entity for transmission/reception via SL (to a WTRU to NW relay). Data on a multipath bearer can be transmitted via the Uu path, the SL path, or both (i.e. duplication). In the case the WTRU is configured for duplication, or decides to enable duplication for a multipath bearer (a duplication bearer), the WTRU may transmit PDCP PDUs both over the Uu path and the SL path.

### A Remote WTRU Autonomously Enables Duplication

According to an embodiment, a remote WTRU may be configured with conditions in which it enables/disables duplication on a multipath bearer. Such conditions may depend on any or a combination of the following factors:
Measurements of Uu quality (e.g. Uu Reference Signal Received Power (RSRP));
Measurements of SL quality (e.g. SL RSRP of the relay, SL Channel Busy Ratio (CBR));
SL scheduling mode (mode 1 vs mode 2);
Buffer status associated with the multipath bearer;
SL Channel Occupance Ratio (CR);
Priority;
Flow control indication/measure received from the relay WTRU;
Availability of SL or Uu resources;
   E.g. whether a grant is present for the data to be transmitted.

According to an embodiment, a remote WTRU may be configured with a condition on SL RSRP and/or Uu RSRP in which duplication can be enabled. Such configuration may be received via an RRC message. For example, if the measured Uu RSRP is below a first threshold, and the measured SL RSRP is below a second threshold, the remote WTRU may enable duplication for the multipath bearer. The remote WTRU may further be configured with a separate Uu RSRP and/or SL RSRP threshold per bearer, per priority, or per flow control measure received from the remote WTRU.

According to an embodiment, a remote WTRU may enable duplication if the Uu quality and the sidelink quality are within a threshold difference/offset from each other.

According to an embodiment, a remote WTRU may enable duplication if the SL CBR is below a first threshold, the SL RSRP is below a second threshold, and the Uu RSRP is below a third threshold.

According to an embodiment, a remote WTRU may enable duplication based on certain conditions only if the SL priority and the Uu priority configured for the multipath bearer are higher than a threshold priority.

### A Remote WTRU May Compensate its Transmissions on One Path Based on Events on Another Path

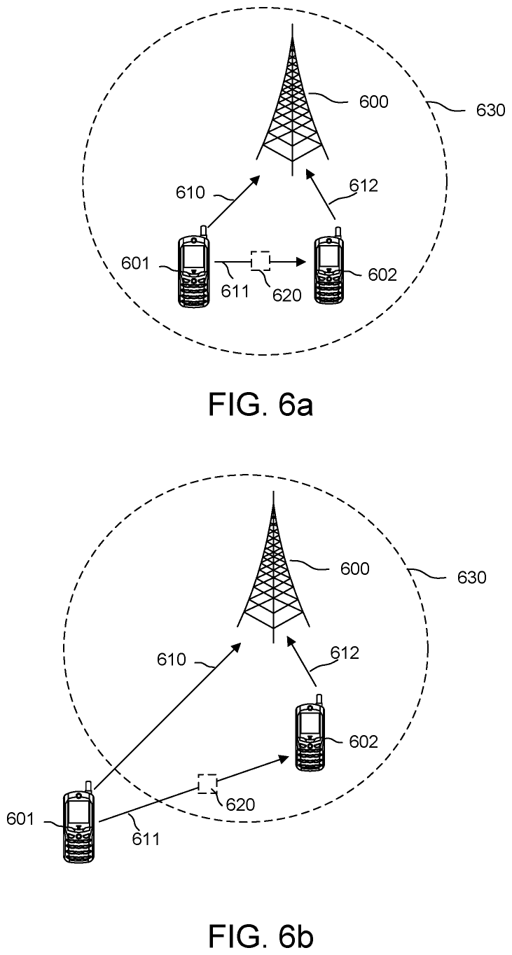

According to an embodiment, a remote WTRU configured in multipath may compensate its transmissions on one path (Uu or SL) based on events occurring on another path (SL or Uu). In FIGS. 6a and 6b, 600 is a network node, e.g., gNB; 601 and 602 are WTRUs, where 602 is a relay WTRU; 610 and 611 are duplication bearers, i.e., 610 is Uu and 611 is side link (SL); 612 is a link between the relay WTRU 602 and the network node 600; 620 is a configured grant, and 630 is a coverage area of network node 600. In FIG. 6a, WTRU 601 is within the coverage area of network node 600; in FIG. 6b, WTRU 601 is outside coverage area of network node 600. The notion of inside/outside network node coverage is for example determined by RSRP at WTRU 601, e.g., high Uu RSRP at WTRU 601 in FIG. 6a, and low Uu RSRP at WTRU 601 in FIG. 6b, where high and low are for example according to a threshold.

According to the embodiment where a remote WTRU configured in multipath may compensate its transmissions on one path (Uu or SL) based on events occurring on another path (SL or Uu), compensation of transmissions may consist of any of the following:
Increase the priority of transmissions:
   For example, this may consist of changing the Logical Channel (LCH) priority of the LCHs associated with duplication, SL and/or Uu, or priority value of transmissions, possibly for a temporary period of time, potentially with respect to any of the operations with respect to that link:
      For example, a remote WTRU could consider the priority of a transmission to be increased when performing UL/SL prioritization decisions;
      For example, a remote WTRU could consider the priority of a transmission to be increased when performing Logical Channel Prioritization (LCP);
      For example, a remote WTRU could increase/decrease the priority of a transmission compared with other transmissions when performing sensing or pre-emption decision. Specifically, a transmission that may normally be preempted (due to its priority) may not be preempted.
   For example, this may consist of increasing/decreasing the Packet Delay Budget (PDB) of transmissions on SL while operating on mode 2:
      For example, a remote WTRU may be configured with a first and second PDB to be used for transmissions associated with a relayed SL LCH. If the WTRU detects problems on the Uu link, the remote WTRU may change from using a first PDB to using a second PDB.
Apply/not apply an LCP restriction:
   For example, a WTRU may be allowed to use a grant for a LCH on one link when it detects problems (e.g., transmission problem, reception problem, channel quality problem, etc.) on another link. Specifically, a WTRU may be configured with an LCP restriction applicable for a particular logical channel. Such restriction may be applied or relaxed temporarily while the WTRU detects a problem (e.g., a transmission problem, a reception problem, a channel quality problem, etc.) on the other link of a multipath link;
   For example, a WTRU may include duplication-only data in a grant (on SL or Uu) when it detects a problem (e.g., transmission problem, reception problem, channel quality problem, etc.) on the other link.
Request and/or initiate change of resource allocation mode:
   For example, a WTRU may request initiation of mode 1 operation on SL when it detects a problem (e.g., transmission problem, reception problem, channel quality problem, etc.) on SL;
   For example, a WTRU may fallback (revert, return) to mode 2 operation on SL when it detects a problem (e.g., transmission problem, reception problem, channel quality problem, etc.) with the Uu link.
Enable SL Hybrid Automatic Repeat Request (HARQ) feedback:
   For example, a SL LCH may be configured to enable SL HARQ feedback only when certain conditions related to an event described herein are met. Specifically, the LCH is configured with SL HARQ feedback disable under normal circumstances, and while the conditions associated with an event are met, the LCH is configured with SL HARQ feedback enabled.
Enable/disable a different sensing mechanism or sensing characteristic:
   For example, this may consist of performing resource selection without sensing results or using partial sensing;
   For example, this may consist of requesting inter-WTRU coordination (IUC) to obtain sensing results.

Transmissions above may be restricted to transmissions associated to multipath only. Transmission above may be restricted to transmissions associated with logical channels that are mapped to bearers where duplication is enabled.

Events related to a path, which may cause compensation on the other path, may consist of any of the following:
Detection of Uu Radio Link Failure (RLF) or SL RLF;
Failure to acquire a shared channel (e.g., Listen-Before-Talk (LBT) failure);
Reception of multiple hybrid automatic repeat request (HARQ) negative acknowledgement (NACK) or HARQ discontinuous transmission (DTX):
   For example, a number of consecutive HARQ NACK, a number of HARQ NACK in a configured window of time, etc.
Measurements of the link (e.g., RSRP, Channel Quality Indicator (CQI), CBR) above/below a certain threshold;
Transmissions to a path are not possible due to Discontinuous Reception (DRX):
   For example, during DRX off for that link.
Indication of mobility received from a relay WTRU:
   Specifically, in SL information message on PC5-RRC.
Indication of Uu RLF received from a relay WTRU:
   Specifically, in SL information message on PC5-RRC.
Reception of an indication (e.g., a MAC Control Element (CE), which indicates the problem of one link) from the network, or from the relay WTRU;
   Flow control indication from the relay WTRU which meet certain criteria (ie., which indicate a certain level of congestion at the relay);
   Preemption of a transmission on SL:
      For example, following a preemption of a schedule transmission by a remote WTRU operating in mode 2.
   Detection that one or more transmission on SL may be performed after the configured PDB
   Buffer status for a multipath bearer:
      For example, when the buffer status for a multipath bearer exceeds a threshold (e.g. the split bearer threshold).

In one embodiment, a WTRU configured with multipath (i.e. one path via direct Uu, and a second path via SL to a WTRU to NW relay) may increase the priority of SL transmissions with respect to UL/SL prioritization when the measured Uu RSRP is below a threshold. Alternatively, the increase of priority can occur when the Uu RSRP is below a threshold, and the SL RSRP of the relay WTRU is above a second threshold. The WTRU may further perform such operation only when considering SL transmissions associated with SL LCHs for multipath bearers and/or bearers configured with multipath duplication. The advantage of such a solution is that it increases the priority of the SL path given that the SL path has better performance.

In another embodiment, a WTRU may be configured with a Uu grant (e.g., a type 1 or type 2 configured grant such as 620) which can be used for situations of SL issues/failures. Specifically, a remote WTRU may normally not be allowed to multiplex a Uu LCH associated with multipath onto such Uu grant. The remote WTRU may relax such LCP restriction and may multiplex data from a Uu LCH associated with multipath upon detection of an event herein, such as following reception of a flow control message from a relay WTRU indicating congestion at the relay (e.g. measure of congestion above a threshold). The remote WTRU may continue to use the Uu grant(s) until subsequent flow control message from the relay indicating the congestion situation is resolved (e.g. measure of congestion below a threshold).

In another embodiment, a WTRU may be configured with a Uu grant with an LCP restriction which does not allow data from a Uu LCH associated with a multipath bearer. The WTRU may temporarily multiplex data from the bearer in the said grant during the period where the relay WTRU is in SL DRX (i.e. the SL DRX off periods).

In another embodiment, a WTRU may be configured with a SL LCP restriction associated with a specific grant. The WTRU may enable the use of such grant for transmission of data from a SL LCH from a multipath bearer when the buffer status associated with the multipath bearer exceeds a threshold.

In another embodiment, a WTRU may be configured with a SL LCP restriction associated with a specific grant. The WTRU may enable the use of such grant for transmission of data from a SL LCH from a multipath bearer when the WTRU detects Uu RLF.

In another embodiment, a WTRU may relax a Uu LCP restriction (i.e., allow data from a Uu LCH into a grant on Uu) following a number of consecutive SL HARQ failures. In addition, the WTRU may enable the Uu LCH data which may be associated with the Uu SL LCH (i.e., corresponding to the same multipath bearer) which experienced the SL HARQ failures.

A Relay WTRU Receives an Indication that Downlink Duplication is Enabled/Disabled

In one embodiment, a relay WTRU may receive an indication that downlink duplication is enabled/disabled for a specific Uu LCH. Specifically, the network may perform duplication for a multipath bearer in downlink, and upon initiating the duplication, may inform a relay WTRU that the Uu LCH that is part of the multipath bearer is being duplicated via the direct link. Alternatively, when duplication of a Uu LCH is being enabled, the WTRU may also receive an indication from the network indicating the duplication in the Uu LCH is disabled. A relay WTRU may receive such indication in an RRC message (e.g., along with the configuration of the LCH) or in a MAC CE. The relay WTRU may perform specific behavior described herein following reception of such indication.

### A Relay WTRU Enables Some Uu/SL Behavior for Duplicated Data

According to an embodiment, a relay WTRU may enable some Uu/SL behavior associated with relayed data. Such data may represent data being duplicated by a remote WTRU on SL and Uu. A relay WTRU may determine whether to perform such behavior based on indication from the remote WTRU and/or the network, possibly of the presence of relayed data. Alternatively, the relay WTRU may be configured to enable such behavior based on the configuration of a LCH associated with a multipath bearer. Alternatively, the relay WTRU may enable such behavior based on similar events described herein for performing actions at the remote WTRU. Such behavior may include any of the following:
Relax/enable an LCP restriction associated with an UL grant to the relay WTRU on Uu:
   For example, a relay WTRU may receive an indication (from a remote WTRU or from the network) that one or more SL LCHs received by the relay WTRU are associated with multipath/duplication at the remote WTRU. Based on such indication, a relay WTRU may allow the use of a Uu grant (e.g. a type 1 or type 2 CG associated with an LCP restriction) for transmission of a Uu LCH to which the SL LCHs have been mapped to by the adaptation layer.
Trigger a dedicated SR upon reception of data from a remote WTRU:
   For example, a relay WTRU may be configured with a dedicated SR for low latency transmissions (e.g., for URLLC, dedicated SR for duplicated data). The relay WTRU may transmit SR using the dedicated SR resource if the data available for transmissions is associated with one or more SL LCHs indicated (e.g. by the remote WTRU or by the gNB) as carrying duplicated/multipath data.
Transmit data on SL using HARQ enabled:
   For example, a relay WTRU may receive an indication that duplication is initiated by network on a multipath bearer and may enable SL HARQ for the associated mapped LCHs on SL.
      A Relay/Remote WTRU Enables an LCP Restriction Associated with Duplicated/Non-Duplicated Data

According to an embodiment, a relay WTRU or a remote WTRU may be configured with an LCP restriction to include only duplicated/multipath data or non-duplicated/non-multipath data into a SL or Uu grant. Specifically, when the WTRU selects a LCH for the grant associated with duplicated/multipath data, the WTRU can only continue to multiplex LCHs associated with duplicated/multipath data. A WTRU can be indicated in the grant that such grant is to be used for duplicated/multipath data only. Alternatively, a WTRU may perform such behavior on any grant. A WTRU may further enable/disable such LCP restriction based on events described herein.

For example, a remote WTRU may be configured with a type 1/2 configured grant on SL (e.g., 620). Such configured grant may have a timing which enables the duplicated transmission on Uu and SL to arrive at a similar time at the network, for example. The remote WTRU may apply an LCP restriction to ensure only duplicated data is included in such a grant.

According to an embodiment, the LCP restriction may be applied implicitly upon reception of a grant on Uu. Specifically, a remote WTRU may receive a Uu grant and may use it to transmit duplicated data. The WTRU may, following such, apply an LCP restriction to a SL grant which occurs within a time window of the Uu grant in order to use it for transmission of duplicated data only.

According to an embodiment, a remote WTRU may perform a resource selection whereby the resource selection window is determined by the timing of the Uu grant. Specifically, the remote WTRU may use the Uu grant and the SL grant for transmission of duplicate data, and may be configured with a maximum time difference between the two grants for use with resource selection.

### A Relay/Remote WTRU May Handle Duplicated Data Differently in UL/SL Prioritization

According to an embodiment, a relay or remote WTRU may handle data associated with multipath/duplication differently than Uu/SL data that is not associated with multipath duplication.

According to an embodiment, a WTRU may prioritize a link (e.g. Uu) if the SL contains duplicated data and the Uu quality is good (e.g. Uu RSRP is above a threshold). The WTRU may prioritize Uu in this case, even when the UL/SL prioritization rules indicate to prioritize SL. For example, the WTRU may apply a priority offset to determine whether to prioritize UL or SL.

According to an embodiment, a relay WTRU may receive an indication that a PDU was successfully transmitted on the direct path, and may drop the duplicated PDU, or deprioritize it with respect to UL/SL prioritization.

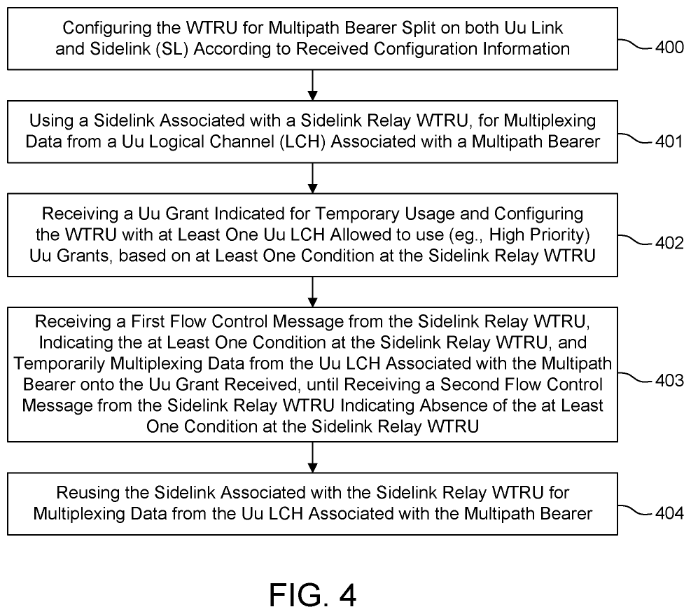

According to an embodiment, there is disclosed a method, implemented by a WTRU, see FIG. 4. The method may comprise:
configuring, 400, the WTRU for multipath bearer split on both Uu link and sidelink (SL) according to received configuration information;
using, 401, a sidelink associated with a sidelink relay WTRU, for multiplexing data from a Uu logical channel (LCH) associated with a multipath bearer;
receiving, 402, a Uu grant indicated for temporary usage and configuring the WTRU with at least one Uu LCH allowed to use (eg., high priority) Uu grants, based on at least one condition at the sidelink relay WTRU;
receiving, 403, a first flow control message from the sidelink relay WTRU, indicating the at least one condition at the sidelink relay WTRU, and temporarily multiplexing data from the Uu LCH associated with the multipath bearer onto the Uu grant received, until receiving a second flow control message from the sidelink relay WTRU indicating absence of the at least one condition at the sidelink relay WTRU; and
reusing, 404, the sidelink associated with the sidelink relay WTRU for multiplexing data from the Uu LCH associated with the multipath bearer.

According to a further embodiment of the method implemented by a WTRU, the at least one condition at the sidelink relay WTRU may be any of:
a congestion at the sidelink relay WTRU;
the sidelink relay WTRU is in a discontinuous reception (DRX) off period.

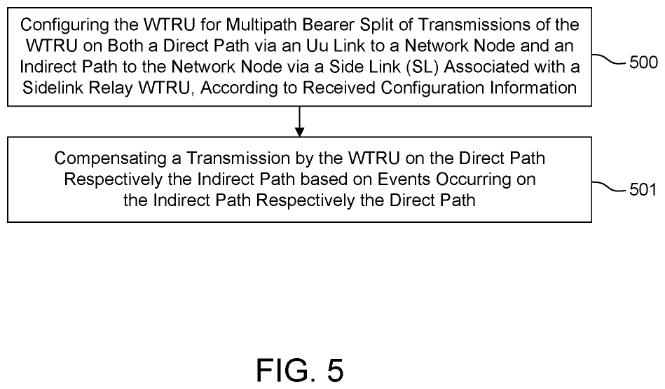

According to an embodiment, there is disclosed a method, implemented by a WTRU, see FIG. 5. The method may comprise:
Configuring, 500, the WTRU for multipath bearer split of transmissions of the WTRU on both a direct path via an Uu link to a network node and an indirect path to the network node via a side link (SL) associated with a sidelink relay WTRU, according to received configuration information; and
Compensating, 501, a transmission by the WTRU on the direct path respectively the indirect path based on events occurring on the indirect path respectively the direct path.

According to a further embodiment of the method, compensating the transmission by the WTRU may comprise any of:
increasing a priority of the transmission;
applying, or not applying, a logical channel prioritization (LCP) decision;
requesting a change of resource allocation mode;
enabling SL hybrid automatic repeat request (HARQ) feedback;
enabling, or disabling, a different sensing mechanism or sensing characteristic.

According to a further embodiment, increasing the priority of the transmission may comprise changing a logical channel priority.

According to a further embodiment, the applying, or not applying the LCP decision may comprise using a grant for a LCH on the SL when a problem is detected on the Uu link, respectively use a grant for a LCH on the Uu link when a problem is detected on the SL.

According to a further embodiment, the requesting a change of resource allocation mode may comprise any of:
requesting initiation of mode 1 on the SL, when a problem is detected on the SL;
fallback from mode 1 operation to mode 2 operation on SL when a problem is detected on the Uu link.

According to a further embodiment, the events occurring may be any of:
detection of radio link failure (RLF) on the Uu link respectively on the SL;
failure to acquire a shared channel on the Uu link respectively on the SL due to a listen before talk (LBT) failure;
reception of a threshold number of hybrid automatic repeat request (HARQ) negative acknowledgement (NACK) or HARQ discontinuous transmission (DTX) on the Uu link respectively on the SL;
measurements on the Uu link respectively the SL being below a threshold, wherein the measurements are any of Reference Signal Received Power (RSRP), Channel Quality Indicator (CQI), Channel Busy Ratio (CBR);
impossibility to transmit on the Uu link respectively on the SL due to discontinuous reception (DRX) off for the Uu link respectively for the SL;
a flow control indication from the sidelink relay WTRU for the SL, indicating a congestion at the sidelink relay WTRU;
a preemption of a transmission on the SL;
a detection that at least one transmission on the SL is to be performed after a configured Packet Delay Budget;
a buffer status for one of the multipath bearer exceeding a threshold.

According to an embodiment, there is disclosed a WTRU comprising at least one processor that may be configured to:
configure the WTRU for multipath bearer split on both Uu link and sidelink (SL) according to received configuration information;
use a sidelink associated with a sidelink relay WTRU, for multiplexing data from a Uu logical channel (LCH) associated with a multipath bearer;
receive a Uu grant indicated for temporary usage and configuring the WTRU with at least one Uu LCH allowed to use (e.g., high priority) Uu grants, based on at least one condition at the sidelink relay WTRU;
receive a first flow control message from the sidelink relay WTRU, the first flow control message indicating the at least one condition at the sidelink relay WTRU, and temporarily multiplex data from the Uu LCH associated with the multipath bearer onto the Uu grant received, until receiving a second flow control message from the sidelink relay WTRU indicating absence of the at least one condition at the sidelink relay WTRU; and reuse the sidelink associated with the sidelink relay WTRU for multiplexing data from the Uu LCH associated with the multipath bearer.

According to a further embodiment of the WTRU, the at least one condition at the sidelink relay WTRU may be any of:
a congestion at the sidelink relay WTRU;
the sidelink relay WTRU is in a discontinuous reception (DRX) off period.

According to an embodiment, there is disclosed a WTRU, comprising at least one processor that may be configured to:
configure the WTRU for multipath bearer split of transmissions of the WTRU on both a direct path via an Uu link to a network node and an indirect path to the network node via a side link (SL) associated with a sidelink relay WTRU, according to received configuration information;
compensate a transmission by the WTRU on the direct path respectively the indirect path based on events occurring on the indirect path respectively the direct path.

According to a further embodiment of the WTRU, compensate the transmission by the WTRU may comprise any of:
increase a priority of the transmission;
apply, or not apply, a logical channel prioritization (LCP) decision;
request a change of resource allocation mode;
enable SL hybrid automatic repeat request (HARQ) feedback;
enable, or disable, a different sensing mechanism or sensing characteristic.

According to a further embodiment of the WTRU increase the priority of the transmission may consist of changing a logical channel priority.

According to a further embodiment of the WTRU, apply, or not apply the LCP decision may comprise use a grant for a LCH on the SL when a problem is detected on the Uu link, respectively use a grant for a LCH on the Uu link when a problem is detected on the SL.

According to a further embodiment of the WTRU, request a change of resource allocation mode may comprise any of:
request initiation of mode 1 on the SL, when a problem is detected on the SL;
fallback to from mode 1 operation to mode 2 operation on SL when a problem is detected on the Uu link.

According to a further embodiment of the WTRU the events occurring may be any of:
detection of radio link failure (RLF) on the Uu link respectively on the SL;
failure to acquire a shared channel on the Uu link respectively on the SL due to a listen before talk (LBT) failure;
reception of a threshold number of hybrid automatic repeat request (HARQ) negative acknowledgement (NACK) or HARQ discontinuous transmission (DTX) on the Uu link respectively on the SL;
measurements on the Uu link respectively the SL being below a threshold, wherein the measurements are any of Reference Signal Received Power (RSRP), Channel Quality Indicator (CQI), Channel Busy Ratio (CBR);
impossibility to transmit on the Uu link respectively on the SL due to discontinuous reception (DRX) off for the Uu link respectively for the SL;
a flow control indication from the sidelink relay WTRU for the SL, indicating a congestion at the sidelink relay WTRU;
a preemption of a transmission on the SL;
a detection that at least one transmission on the SL is to be performed after a configured Packet Delay Budget;
a buffer status for one of the multipath bearer exceeding a threshold.

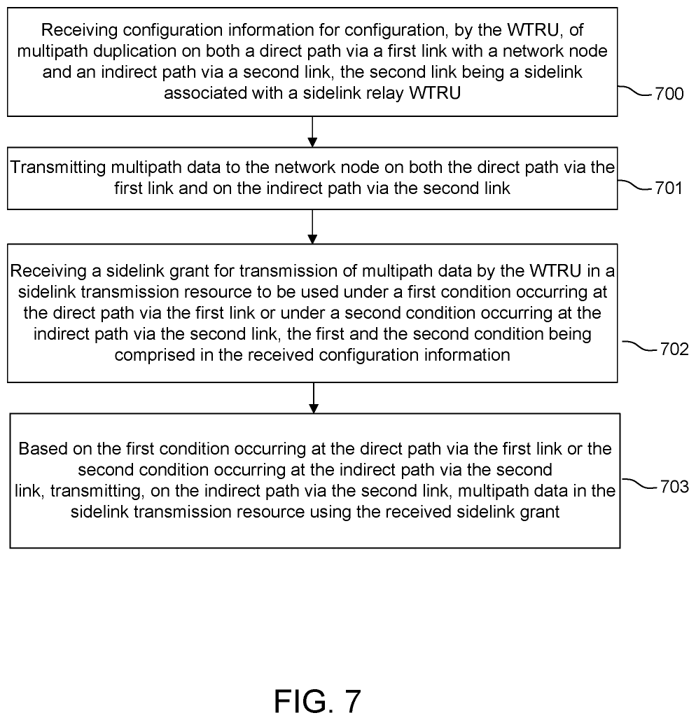

An embodiment of a method implemented by a WTRU is shown in FIG. 7. The WTRU is for example WTRU 601 of FIGS. 6a-b.

The method comprises, in 700, receiving configuration information for configuration, by the WTRU (e.g., 601), of multipath duplication on both a direct path via a first link (e.g., 610) with a network node (e.g., 600) and an indirect path via a second link (e.g., 611), the second link being a sidelink associated with a sidelink relay WTRU (e.g., 602).

The method comprises, in 701, transmitting, by the WTRU, multipath data to the network node on both the direct path via the first link and on the indirect path via the second link.

The method comprises, in 702, receiving, by the WTRU, a sidelink grant for transmission of multipath data by the WTRU in a sidelink transmission resource (e.g., a configured grant 620) to be used under a first condition occurring at the direct path via the first link or under a second condition occurring at the indirect path via the second link, the first and the second condition being comprised in the received configuration information.

The method comprises, in 703, based on the first condition occurring at the direct path via the first link or the second condition occurring at the indirect path via the second link, transmitting, on the indirect path via the second link, multipath data in the sidelink transmission resource using the received sidelink grant.

According to an embodiment of the method, the first condition occurring at the direct path via the first link is determined based on comparing measured reference signal received power on the first link to a reference signal received power value comprised in the received configuration information.

According to an embodiment of the method, the first condition occurring at the direct path via the first link is the measured reference signal received power on the first link being lower than the reference signal received power value comprised in the received configuration information. This is for example illustrated in FIGS. 6a and 6b by WTRU 601 being inside of outside of circle 630, in FIG. 6a WTRU 601 is e.g., within ‘good reception range’ or ‘within coverage area’ of network node 600 (e.g., measured reference signal received power on the first link is equal or higher (or e.g., higher) than reference signal received power value comprised in received configuration information), whereas in FIG. 6b WTRU 602 is not e.g., within ‘good reception range’ or ‘within coverage area’ of network node 600 (e.g., measured reference signal received power on the first link is lower (or e.g., equal or lower) than reference signal received power value comprised in received configuration information).

According to an embodiment of the method, the second condition occurring at the indirect path via the second link is determined based on receipt of a message from the sidelink relay WTRU indicating a congestion at the sidelink relay WTRU.

According to an embodiment of the method, the message indicates the congestion at the sidelink relay WTRU being higher than a threshold.

There is also disclosed a wireless transmit-receive unit (e.g., 601), WTRU, comprising at least one processor.

The at least one processor is configured to receive configuration information for configuration of multipath duplication on both a direct path via a first link with a network node and an indirect path via a second link, the second link being a sidelink associated with a sidelink relay WTRU.

The at least one processor is configured to transmit multipath data to the network node on both the direct path via the first link and on the indirect path via the second link.

The at least one processor is configured to receive a sidelink grant for transmission of multipath data by the WTRU in a sidelink transmission resource to be used under a first condition occurring at the direct path via the first link or under a second condition occurring at the indirect path via the second link, the first and the second condition being comprised in the received configuration information.

The at least one processor is configured to, based on the first condition occurring at the direct path via the first link or the second condition occurring at the indirect path via the second link, transmit, on the indirect path via the second link, multipath data in the sidelink transmission resource using the received sidelink grant.

According to an embodiment, the first condition occurring at the direct path via the first link is determined based on comparing, by the at least one processor, measured reference signal received power on the first link to a reference signal received power value comprised in the received configuration information.

According to an embodiment, the first condition occurring at the direct path via the first link is the measured reference signal received power on the first link being lower than the reference signal received power value comprised in the received configuration information.

According to an embodiment, the second condition occurring at the indirect path via the second link is determined, by the at least one processor, based on receipt of a message from the sidelink relay WTRU indicating a congestion at the sidelink relay WTRU.

According to an embodiment, the message indicates the congestion at the sidelink relay WTRU being higher than a threshold.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1-10. (canceled)

11. A method, implemented by a wireless transmit-receive unit (WTRU), the method comprising:
receiving configuration information for configuration, by the WTRU, of multipath duplication on both a direct path via a first link with a network node and an indirect path via a second link, the second link being a sidelink associated with a sidelink relay WTRU;
transmitting multipath data to the network node on both the direct path via the first link and on the indirect path via the second link;
receiving a first sidelink grant for transmission of multipath data by the WTRU in a sidelink transmission resource and a second sidelink grant to be used under a first condition occurring at the direct path via the first link or under a second condition occurring at the indirect path via the second link, the first and the second condition being comprised in the configuration information; and
based on the first condition occurring at the direct path via the first link or the second condition occurring at the indirect path via the second link, transmitting, to the network node, same multipath data via both the direct path via the first link using the first sidelink grant and the indirect path via the second link using the second sidelink grant.

12. The method of claim 11, wherein the first condition occurring at the direct path via the first link is determined based on comparing measured reference signal received power on the first link to a reference signal received power value comprised in the configuration information.

13. The method of claim 12, wherein the first condition occurring at the direct path via the first link is the measured reference signal received power on the first link being lower than the reference signal received power value comprised in the configuration information.

14. The method of claim 11, wherein the second condition occurring at the indirect path via the second link is determined based on receipt of a message from the sidelink relay WTRU indicating a congestion at the sidelink relay WTRU.

15. The method of claim 14, wherein the message indicates the congestion at the sidelink relay WTRU being higher than a threshold.

16. A wireless transmit-receive unit (WTRU), comprising at least one processor configured to:
receive configuration information for configuration of multipath duplication on both a direct path via a first link with a network node and an indirect path via a second link, the second link being a sidelink associated with a sidelink relay WTRU;
transmit multipath data to the network node on both the direct path via the first link and on the indirect path via the second link;
receive a first sidelink grant for transmission of multipath data by the WTRU in a sidelink transmission resource and a second sidelink grant to be used under a first condition occurring at the direct path via the first link or under a second condition occurring at the indirect path via the second link, the first and the second condition being comprised in the configuration information; and
based on the first condition occurring at the direct path via the first link or the second condition occurring at the indirect path via the second link, transmit, to the network node, same multipath data via both the direct path via the first link using the first sidelink grant and the indirect path via the second link using the second sidelink grant.

17. The WTRU of claim 16, wherein the first condition occurring at the direct path via the first link is determined based on comparing, by the at least one processor, measured reference signal received power on the first link to a reference signal received power value comprised in the configuration information.

18. The WTRU according to claim 17, wherein the first condition occurring at the direct path via the first link is the measured reference signal received power on the first link being lower than the reference signal received power value comprised in the configuration information.

19. The WTRU of claim 16, wherein the second condition occurring at the indirect path via the second link is determined, by the at least one processor, based on receipt of a message from the sidelink relay WTRU indicating a congestion at the sidelink relay WTRU.

20. The WTRU of claim 19, wherein the message indicates the congestion at the sidelink relay WTRU being higher than a threshold.
